(19) United States
(12) Patent Application Publication
(10) Pub. No.: US 2013/0043406 A1
(43) Pub. Date: Feb. 21, 2013

(54) LUMINESCENT COMPOUNDS

(71) Applicants: Arnaud Huignard, Compiegne (FR); Mathieu Berard, Paris (FR); Isabelle Etchart, Hasparren (FR); Anthony K. Cheetham, Santa Barbara, CA (US)

(72) Inventors: Arnaud Huignard, Compiegne (FR); Mathieu Berard, Paris (FR); Isabelle Etchart, Hasparren (FR); Anthony K. Cheetham, Santa Barbara, CA (US)

(73) Assignees: Cambridge Enterprise Limited, Cambridge (GB); Saint-Gobain Glass France, Courbevoie (FR)

(21) Appl. No.: 13/579,336

(22) PCT Filed: Feb. 14, 2011
(86) PCT No.: PCT/FR2011/050303

§ 371 Date: Oct. 4, 2012

(30) Foreign Application Priority Data
Feb. 17, 2010 (FR) 1051126

(51) Int. Cl. C09K 11/78; F21V 9/16

(52) U.S. Cl. 250/459.1; 252/587

(57) ABSTRACT

A crystalline phosphor of formula:

Ln_{x.(1-t1-t2-t3-t4)}Yb_{x.t1}Er_{x.t2}Tm_{x.t3}Ho_{x.14}Ba_{y}Zn_{z}O_{1.5x+y+z}
in which:
   Ln is Y, Gd or La;
   t1+t2+t3+t4 varies from 0.001 to 0.3;
   and such that, when x=2, y=1 and z=1:
   t1+t3+t4 is nonzero;
   if Ln is La or Gd and if t3+t4 is zero, then t1 varies from 0.05 to 0.1 and t2 varies from 0.02 to 0.07; and
   if Ln is Gd, then t2+t4 is nonzero.

The present invention relates to the field of phosphor materials, more particularly to what are called “upconversion” phosphor materials, capable of emitting radiation of higher energy (of shorter wavelength) than that of the incident radiation.

Most phosphors have the particular feature, when they are exposed to radiation of a given wavelength, to re-emit second radiation having a higher wavelength, and therefore a lower energy, than that of the incident radiation.

However, phosphors capable of emitting radiation of higher energy than the incident radiation have recently been discovered, these being called upconversion phosphors. This phenomenon, which is explained by successive absorptions of several photons by one and the same ion or by absorptions by different ions followed by energy transfers between said ions, is extremely rare. It occurs in fact only for a few ions, in particular for rare-earth ions or transition metal ions, when these are in a favorable environment. Furthermore, the associated luminescence efficiency is generally very low since the probability of the phenomenon occurring is itself very low. The luminescence efficiency is defined as the ratio of the amount of light energy emitted at a wavelength lower than the excitation wavelength to the amount of light energy absorbed by the material.

The upconversion phenomenon, which makes it possible to obtain higher efficiencies, is called “photon addition by energy transfer (PAET)” or “energy transfer upconversion (ETU)”. This phenomenon involves two ions (whether identical or different) that are initially in an excited energy level and a nonradiative energy transfer between these two ions.

Most upconversion phosphors are crystalline solids of the oxide or halide (especially fluoride) type that are doped with lanthanide ions (also called “rare earth” ions). For example, the phosphor Y₂O₃ doped with Er³⁺ ions is known that enables radiation in the near infrared range to be converted into radiation in the visible range. Phosphors also include yttrium fluoride YF₃ doped with Yb³⁺ and Er³⁺ ions (denoted by YF₃:Yb³⁺/Er³⁺).

The application WO 2009/056753, in the name of the present applicant, describes oxides having in the case of some of them high luminescence efficiencies, namely Y₂BaZnO₅:Er³⁺, La₂BaZnO₅:Er³⁺, Gd₂BaZnO₅:Er³⁺, Gd₂BaZnO₅:Yb³⁺/Er³⁺ and Gd₂BaZnO₅:Yb³⁺/Tm³⁺. These phosphors undergo upconversion in the sense that they are capable of converting radiation with a wavelength lying within the infrared (typically 975 nm) into visible radiation, mainly in the green range (about 550 nm) and in the red range (about 660 nm). The luminescence efficiency is high and may even reach values in excess of 1% for the Yb³⁺/Er³⁺-doped Gd₂BaZnO₅ phosphor containing 1% erbium and 10% ytterbium, having the formula Gd_{1.78}Yb_{0.2}Er_{0.02}BaZnO₅.

The object of the invention is to provide novel oxide-based upconversion phosphors of even higher luminescence efficiency.

For this purpose, one subject of the invention is a crystalline phosphor of formula:

Ln_{x.(1-t1-t2-t3-t4)}Yb_{x.t1}Er_{x.t2}Tm_{x.t3}Ho_{x.t4}Ba_{y}Zn_{z}O_{1.5x+y+z}

in which:
Ln is or Gd;
t1+t2+t3+t4 varies from 0.001 to 0.3, preferably from 0.007 to 0.2, or even from 0.01 to 0.2; and such that, when x=2, y=1 and z=1:
   t1+t3+t4 is nonzero;
   if Ln is Gd and if t3+t4 is zero, then t1 varies from 0.05 to 0.1 and t2 varies from 0.02 to 0.07; and
   if Ln is Gd, then t2+t4 is nonzero.

The phosphor according to the invention is preferably such that x=2, y=1 and z=1. The phosphor is then of the Ln₂BaZnO₅ type, more precisely of the Y₂BaZnO₅ or Gd₂BaZnO₅ type, each of these phosphors being doped with at least one or at least two, three or even four rare-earth ions, E³⁺, Yb³⁺, Tm³⁺ or Ho³⁺.

Other combinations are also possible, among which are those with x=8, y=5 and z=4 (a phosphor of the Ln₈Ba₅Zn₄O₂₁ type) or x=2, y=2 and z=8 (a phosphor of the Ln₂Ba₂Zn₈O₁₃ type).

These phosphors of the LnₓBa_{y}Zn_{z}O_{1.5x+y+z} type are advantageous, especially as regards fluorides such as for example NaYF₄, since the appearance of upconversion is manifested by much lower power densities, typically of the order of 10 mW/mm², or even less. In certain cases, power densities of only 0.2 mW/mm² prove to be sufficient.

In the crystalline structures of the phosphors according to the invention, the dopant ion (Yb³⁺, Er³⁺, Tm³⁺ or Ho³⁺) are substituted for the Ln³⁺ (Y³⁺ or Gd³⁺) ion. The parameters t1 to t4 correspond to the molar fraction of Ln³⁺ ion substituted by the corresponding dopant ion. These parameters are also called the “contents” or “concentrations” of the dopant ions.

Ln is chosen from Y and Gd, as these ions enable the highest luminescence efficiencies to be achieved. Ln is preferably Y, as this element has proved to be capable of obtaining crystallized phosphors for an equivalent synthesis time. The phosphor according to the invention is therefore preferably of the Gd₂BaZnO₅, better still Y₂BaZnO₅, type.

Preferably, t1+t2+t3 is greater than or equal to 0.05 and/or t1+t4 is greater than or equal to 0.05.

The phosphor according to the invention preferably contains the Yb³⁺ ion, which has an absorption cross section around 980 nm about ten times higher than that of erbium, thulium or holmium ions. The parameter t1 is therefore advantageously greater than or equal to 0.01, or even greater than or equal to 0.05. Such phosphors have an absorption in the infrared in a relatively broad wavelength range, between 890 and 1100 nm, preferably between 970 and 980 nm. This is particularly the case for phosphors such as those with x=2, y=1 and z=1.

A first family of preferred phosphors is such that, especially when x=2, y=1 and z=1:
Ln is preferably Y;
t3+t4 is zero;
t1 varies from 0.05 to 0.1, preferably from 0.07 to 0.09; and
t2 varies from 0.02 to 0.07, preferably from 0.03 to 0.04.

These phosphors are especially of the Y₂BaZnO₅ and Gd₂BaZnO₅ type codoped with Er³⁺ and Yb³⁺ ions and have, by specifically choosing erbium and ytterbium concentrations, much higher luminescence efficiencies than the phosphors known from the aforementioned patent application WO 2009/056753. Particularly efficient phosphors have the following formulae: Y_{1.8}Yb_{0.14}Er_{0.06}BaZnO₅ and Gd_{1.8}Yb_{0.14}Er_{0.06}BaZnO₅ (t1=0.07 and t2=0.03).

When excited by infrared radiation (with a wavelength between 890 and 1100 nm, and especially around 975 nm), the phosphors of this family emit very strongly in the green (at around 550 nm) and in the red (at around 670 nm). These phosphors also undergo upconversion when they are excited in other wavelength ranges. For example, excitation in the red (at around 660 nm) makes it possible to obtain luminescence in the green (at around 550 nm) and in the ultraviolet. Excitation in the near infrared (at around 800 nm) makes it possible to obtain emission in the red (at around 670 nm) and in the green (at around 550 nm). The observed efficiencies are however lower than those obtained by irradiation in the infrared.

The doping ranges indicated make it possible to achieve extremely high luminescence efficiencies, in excess of 3%, and even 5%. By increasing the Yb³⁺ content it is possible to accentuate the red component to the detriment of the green component.

A second family of preferred phosphors is such that, especially when x=2, y=1 and z=1:
Ln is Y;
t2+t4 is zero; and
t1 and t3 are nonzero, t1 preferably varying from 0.03 to 0.2, especially from 0.05 to 0.2 or even from 0.5 to 0.1, and t3 preferably varying from 0.001 to 0.05, especially from 0.001 to 0.01 or even from 0.001 to 0.005.

These phosphors are especially of the Y₂BaZnO₅ type codoped with Yb³⁺ and Tm³⁺ ions. Particularly efficient phosphors have the following formulae: Y_{1.78}Yb_{0.2}Tm_{0.02}BaZnO₅ (t1=0.1 and t3=0.01) or Y_{1.875}Yb_{0.12}Tm_{0.005}BaZnO₅ (t1=0.06 and t3=0.0025).

When excited by infrared radiation (in the 890-1100 nm range and more particularly around 975 nm), the phosphors of this family emit at around 800 nm (in the infrared), 650 nm (in the red) and 480 nm (in the blue) with a luminescence efficiency exceeding 1%. The color perceived by the eye is blue. These phosphors also undergo upconversion when they are excited in other wavelength ranges. For example, excitation in the near infrared (at around 800 nm) makes it possible to emit in the red (at around 650 nm) and in the blue (at around 480 nm). However, the observed efficiencies are lower than those obtained by irradiation in the infrared.

Beside a higher efficiency, by choosing Y rather than Gd it is possible to obtain better crystallized phosphors for an equivalent synthesis time.

For a constant Yb³⁺ content (for example such that t1=0.1), the intensity ratio between emission in the blue and emission in the infrared decreases when the Tm³⁺ content increases.

A third family of preferred phosphors is such that, especially when x=2, y=1 and z=1:
t2+t3=0; and
t1 and t4 are nonzero.

These phosphors are especially of the Y₂BaZnO₅ or Gd₂BaZnO₅ type codoped with Yb³⁺ and Ho³⁺ ions.

When excited by infrared radiation (at between 890 and 1100 nm, and more particularly at around 975 nm), the phosphors of this phosphor emit strongly at around 550 nm (in the green) and more weakly at around 660 nm and 760 nm (in the red and near infrared), with a luminescence efficiency possibly exceeding 2%. The color perceived by the eye is a very bright green. These phosphors also undergo upconversion when they are excited in other wavelength ranges. For example, excitation in the red (at around 660 nm) also makes it possible to obtain luminescence in the green (at around 550 nm). Excitation in the near infrared (at around 800 nm) makes it possible to emit in the red and in the green. However, the observed efficiencies are lower than those obtained by irradiation in the infrared.

The highest luminescence efficiencies are obtained, in particular for phosphors of formula Y₂BaZnO₅ and Gd₂BaZnO₅ codoped with Yb³⁺ and Ho³⁺ ions, when t1 varies from 0.06 to 0.12 and t4 varies from 0.001 to 0.02, especially from 0.003 to 0.012. The phosphors of formulae Y_{1.85}Yb_{0.14}Ho_{0.01}BaZnO₅ (t1=0.07 and t4=0.005) and Y_{1.81}Yb_{0.18}Ho_{0.01}BaZnO₅ (t1=0.09 and t4=0.005) have luminescence efficiency greater than 2%.

A fourth family of preferred phosphors is such that, especially when x=2, y=1, z=1 and t1, t2 and t3 are nonzero, t4 may be zero or nonzero, preferably zero.

These phosphors are especially of the Y₂BaZnO₅ or Gd₂BaZnO₅ type codoped with at least three ions: Yb³⁺, Er³⁺ and Tm³⁺. The Ho³⁺ ion may also be added to these phosphors. Here again, the choice of Y is preferred.

These phosphors emit simultaneously in the green (by virtue of the Er³⁺ ion and optionally the Ho³⁺ ion), in the red (by virtue of the Er³⁺ ion) and in the blue (by virtue of Tm³⁺ ion). The various components (red, green and blue) may be adjusted by the dopant content so as to obtain any desired color. Good mixing of the three emission colors enables white light to be emitted. White light is typically obtained for t1=0.1, t3=0.01 and t2 between 0.002 and 0.005.

A blend of Ln₂BaZnO₅:Yb³⁺/Er³⁺- and Ln₂BaZnO₅:Yb³⁺/Tm³⁺-type phosphors, with or without addition of phosphors of the Ln₂BaZnO₅:Yb³⁺/Ho³⁺ type, also makes it possible to obtain any desired color, and especially emission of white light, under irradiation in the infrared (in the 890-1100 nm range and more particularly at around 975 nm). The subject of the invention is also a blend of at least two different phosphors according to the invention. In particular, a blend of two different phosphors or three different phosphors is preferred. The preferred blends include the following blends:
a blend comprising (or consisting of) a first phosphor of the first preferred family (t3+t4=0 and both t1 and t2 nonzero, especially Y₂—BaZnO₅:Yb³⁺/Er³⁺) and a second phosphor of the second preferred family (t2+t4=0, and both t1 and t3 nonzero, especially Y₂BaZnO₅:Yb³⁺/Tm³⁺; and
a blend comprising (or consisting of) a first phosphor of the first preferred family (t3+t4=0, and both t1 and t2 nonzero, especially Y₂BaZnO₅:Yb³⁺/Er³⁺), a second phosphor of the second preferred family (t2+t4=0 and both t1 and t3 nonzero, especially Y₂BaZnO₅:Yb³⁺/Tm³⁺) and a third phosphor of the third preferred family (t2+t3=0 and both t1 and t4 nonzero, especially Y₂BaZnO₅:Yb³⁺/Ho³⁺).

In the case of the first preferred blend, white light is typically obtained for a mass of the second phosphor which is 20 to 35 times (especially 25 to 30 times) higher than the mass of the first phosphor.

The subject of the invention is also the processes for obtaining the phosphors according to the invention.

These phosphors may be obtained by a solid-phase process, i.e. a process comprising the steps consisting in blending powders, typically oxide powders or carbonate powders, in milling the blend, optionally in pressing it to form a pellet and then in heating the blend so as to make the powders react chemically with one another. The powders are for example Gd₂O₃, Y₂O₃, Yb₂O₃, Er₂O₃, Tm₂O₃, Ho₂O₃, ZnO or BaCo₃ powders.

Nanoparticles may be obtained by milling the resulting powders, for example by a ball milling technique.

The phosphors according to the invention may also be obtained by a sol-gel process comprising the steps consisting in dissolving precursors (typically nitrates, acetates or even carbonates) in water or in a predominantly aqueous solvent, in adding a complexing agent (typically an α-hydroxycarboxylic acid such as citric acid) and optionally a crosslinking agent (typically a polyhydroxyalcohol such as ethylene glycol) so as to obtain a gel, and then in heating the resulting gel normally at a temperature of at least 1000° C. Compared with the solid-phase process, the sol-gel process generally makes it possible to obtain better homogeneity. By heating to at least 1000° C. it is possible to obviate drawbacks associated with this process, especially a higher impurity (CO₂, water, etc.) content that increases the probability of structural defects occurring.

The subject of the invention is also the use of the phosphors according to the invention for converting infrared radiation into visible radiation, especially for converting radiation having a wavelength in the range from 890 to 1100 nm, especially of about 975 nm, into radiation having a wavelength of about 550 nm and/or 660 nm and/or 480 nm and/or 800 nm.

This upconversion phenomenon, which converts infrared radiation into visible radiation (in the blue, green or red, or any type of color, especially white, by mixing several different phosphors or by doping one phosphor with three different dopants) may be advantageous in many applications, in particular in the following fields: displays; imaging (especially medical imaging); lasers; photovoltaic energy production; anti-counterfeiting; and identification.

In the laser field, the phosphors according to the invention may convert infrared laser radiation (for example at around 980 nm) into laser radiation in the green, blue or red, or in any desired color. Advantageously, they may replace the frequency-doubling phosphors currently employed, which are based on second harmonic generation.

In the field of medical imaging, the phosphors according to the invention may serve as luminescent markers in fluorescence imaging techniques. Compared to existing methods, the advantage lies in the possibility of using an excitation light source emitting in the infrared, and not in the ultraviolet, since ultraviolet radiation is liable to create lesions in tissue and generates undesirable background noise due, to the endogenous fluorescence of biological tissue.

The phosphors according to the invention may be incorporated into coatings deposited on any substrate. Such a coated substrate may advantageously be used in the field of photovoltaic energy production and in the display field. The subject of the invention is therefore also a substrate coated over at least part of at least one of its faces with a coating incorporating at least one phosphor according to the invention and to a display device or a photovoltaic energy production device comprising at least one such coated substrate.

Depending on the intended application, the substrate may be transparent, opaque or even translucent. It may be an organic, metallic or mineral substrate, for example of the glass, ceramic or glass-ceramic type containing hydraulic binder (plaster, cement, lime, etc.). The substrate may be flat or curved.

The phosphors according to the invention may be incorporated into the coating using various techniques. The thin layer may especially comprise the phosphors according to the invention within a binder. This binder may especially be of organic nature (for example of the ink, paint, lacquer or varnish type) or of mineral nature (for example a glaze, an enamel or a binder of the sol-gel type). Depending on the nature of the binder, various forming methods are possible: spraying deposition, curtain coating, dip coating, wiping-on, screen printing, spray gun coating, etc. The coating may also consist of at least one phosphor according to the invention and may be deposited by various CVD (chemical vapor deposition) or PVD (especially sputtering) techniques.

A clear glass substrate coated on one of its faces with coating incorporating at least one phosphor according to the invention may for example be used as the frontside substrate of a photovoltaic cell. The term “frontside substrate” is, understood to mean the substrate through which the solar radiation first passes. A substrate coated on one of its faces with a coating incorporating at least one phosphor according to the invention may alternatively or additionally be used as the backside substrate of a photovoltaic cell, optionally combined with a device ensuring reflection (whether diffuse or specula) back toward the photovoltaic material. Whatever the configuration, the presence of the phosphors according to the invention enables part of the infrared radiation to be converted into visible radiation at wavelengths in which the quantum efficiency of the photovoltaic material is higher. For example, the maximum quantum efficiency lies at around 640 nm for cadmium telluride, 540 nm for amorphous silicon and 710 nm for microcrystalline silicon.

A substrate coated on one of its faces with a coating incorporating at least one phosphor according to the invention May also be used in a display device, the selective irradiation by an infrared laser enabling visible light, of various colors, to appear. The display device may as an example be a screen or a head-up display (HUD) device used for example in vehicles for land, air, rail or maritime transportation. The coated substrate according to the invention may therefore be glazing, for example a vehicle windshield, or it may be incorporated into such glazing. Such systems currently sold employ fluorescent phosphors incorporated into laminated windshields (they are generally deposited on or within the lamination interlayer), which phosphors emit visible radiation when they are irradiated by a laser emitting in the ultraviolet. The phosphors according to the invention may advantageously replace these fluorescent phosphors, thereby enabling a laser emitting in the infrared to be used, for example a diode laser, which is markedly less expensive and less hazardous than a laser emitting in the ultraviolet.

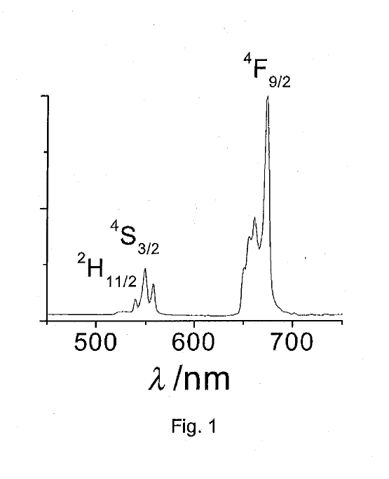

The invention will be better understood on reading the following examples, illustrated by FIGS. 1 to 8.

FIG. 1 is a typical emission spectrum of a phosphor of the Y₂₍₁₋ₜ₁₋ₜ₂₎Yb₂ₜ₁Er₂ₜ₂BaZnO₅ type when it is irradiated with radiation having a wavelength of about 975 nm.

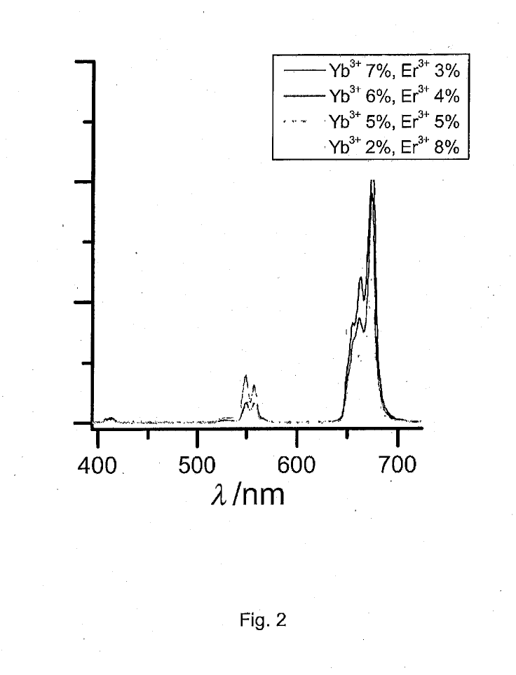

FIG. 2 superimposes several emission spectra of phosphors of the Y₂₍₁₋ₜ₁₋ₜ₂₎Yb₂ₜ₁Er₂ₜ₂BaZnO₅ type, for a constant (t1+t2) content, with t2 varying from 0.03 to 0.08.

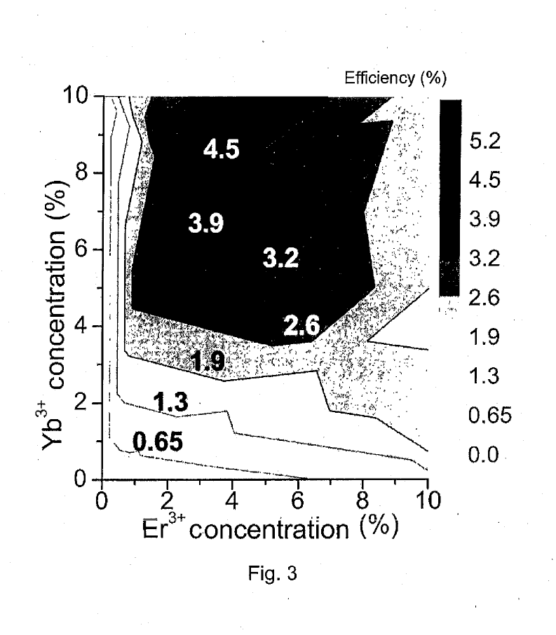

FIG. 3 is a map showing the luminescence efficiency obtained for phosphors of the Y₂₍₁₋ₜ₁₋ₜ₂₎Yb₂ₜ₁Er₂ₜ₂BaZnO₅ type as a function of the Yb³⁺ (t1) and Er³⁺ (t2) concentrations.

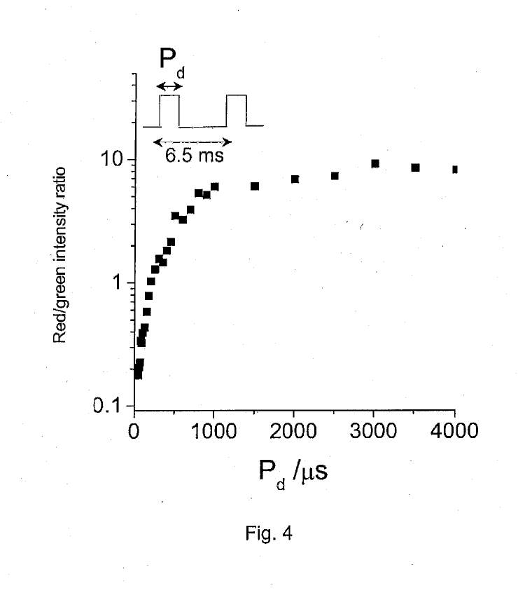

FIG. 4 is an experimental curve in which the red/green intensity ratio is plotted on the y-axis as a function of the laser pulse duration.

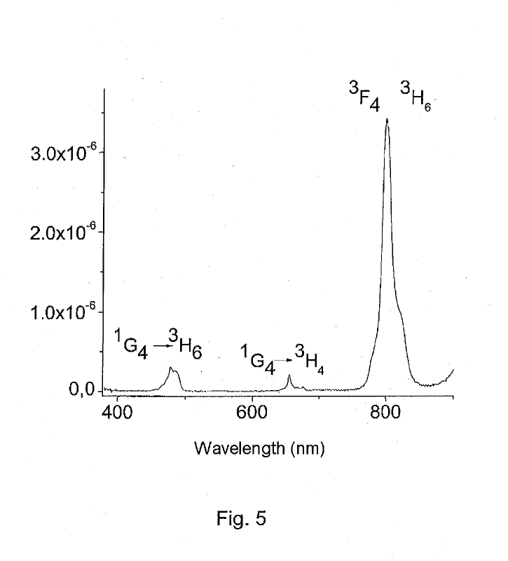

FIG. 5 is a typical emission spectrum of a phosphor of the Y₂₍₁₋ₜ₁₋ₜ₃₎Yb₂ₜ₁Tm₂ₜ₃BaZnO₅ type when it is irradiated with infrared radiation having a wavelength of about 975 nm.

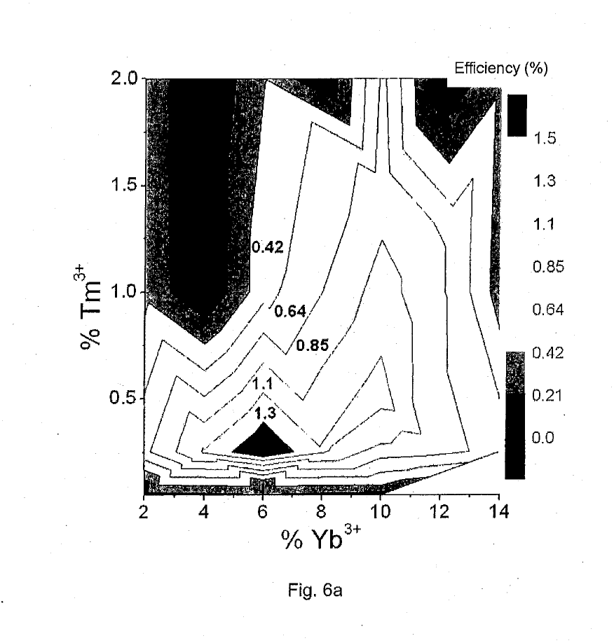

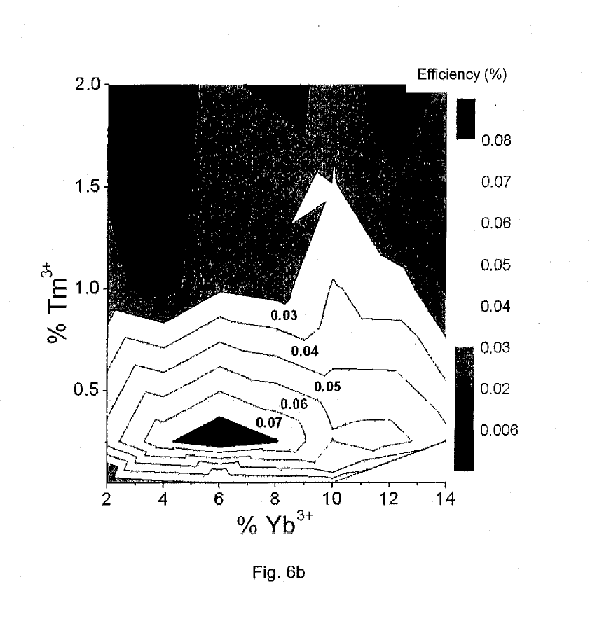

FIGS. 6a and 6b are maps showing the luminescence efficiency obtained for phosphors of the Y₂₍₁₋ₜ₁₋ₜ₃₎Yb₂ₜ₁Tm₂ₜ₃BaZnO₅ type as a function of the Yb³⁺ (t1) and Tm³⁺ (t3) concentrations in the emission range from 420 to 870 nm (FIG. 6a) and that from 420 to 530 nm (FIG. 6b).

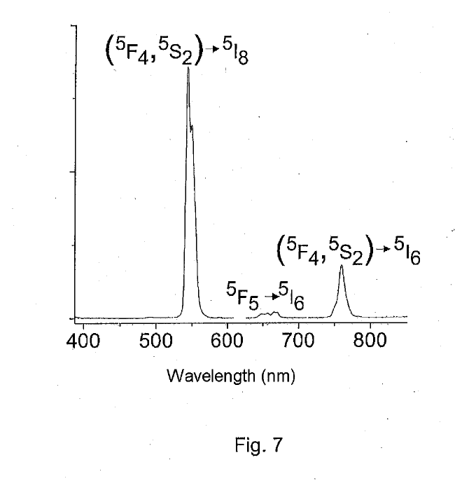

FIG. 7 is a typical emission spectrum of a phosphor of the Y₂₍₁₋ₜ₁₋ₜ₄₎Yb₂ₜ₁Ho₂ₜ₄BaZnO₅ type when it is irradiated with infrared radiation having a wavelength of about 975 nm.

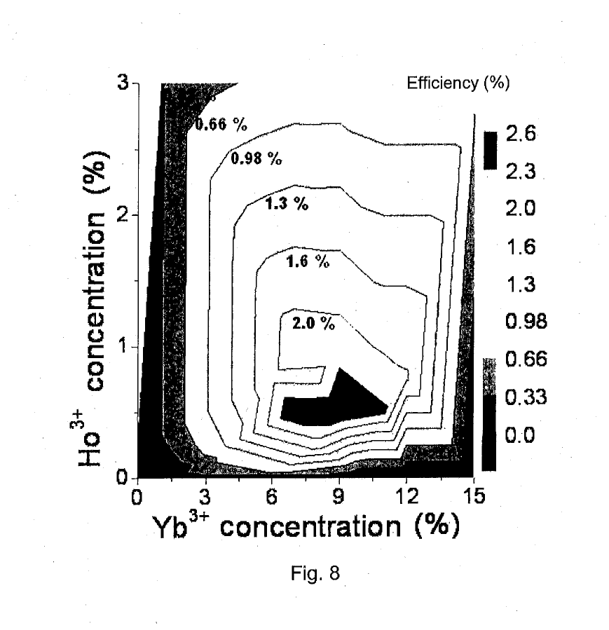

FIG. 8 is a map showing the luminescence efficiency obtained for phosphors of the Y₂₍₁₋ₜ₁₋ₜ₄₎Yb₂ₜ₁Ho₂ₜ₄BaZnO₅ type as a function of the Yb³⁺ (t1) and Ho³⁺ (t4) concentrations.

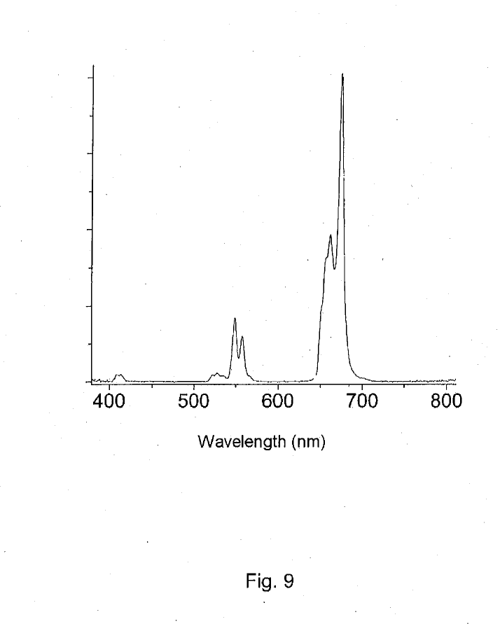

FIG. 9 is a typical emission spectrum of a phosphor of formula Y_{1.8}Yb_{0.14}Er_{0.06}BaZnO₅ incorporated into a coating deposited on a glass substrate, when it is irradiated with infrared radiation having a wavelength of about 975 nm.

In all the examples, upconversion is characterized by determining, using a spectrophotometer, the emission spectrum of the phosphor when it is exposed to coherent radiation having a wavelength of about 975 nm.

More precisely, the phosphors are milled and the resulting powder is held between two quartz plates. The specimens are excited using a continuous laser diode (Thorlabs, L980P100 and TCLDM9) controlled by a laser controller (ILX-Lightwave LDC-3742) and pulsed using a function generator (Agilent Hewlett Packard 33120A) or a pulsed current source (ILX Lightwave LDP-3811). The emission in the visible is recorded using a conventional device comprising a monochromator and detected using a silicon photodiode (Newport Si 818-UV).

The upconversion luminescence is also characterized by determining the luminescence efficiency.

To do this, radiation output by a laser diode, having a wavelength centered around 977 nm, is focused and passed through the specimen. The intensity emitted by the specimen is then measured using an integrating sphere and divided by the intensity absorbed by the specimen.

More precisely, the phosphors are milled and the resulting powder is held in a specimen holder consisting of two quartz plates, one of which is coated with an aluminum reflecting layer. The specimen holder is then placed on the rear face of an integrating sphere (Instrument Systems, ISP-150-100). The excitation signal is focused onto the center of the specimen using a lens. The measurement is carried out in two steps. In a first step, the specimen holder is empty (no powder is present) and the signal is collected by an optical fiber and analyzed using a spectrometer (Instrument Systems, CAS 140B). In a second step, the powder is placed in the specimen holder and both that fraction of the excitation light that has not been absorbed by the specimen and the emitted upconversion light are measured. The luminescence efficiency, which corresponds to the ratio of the emission in the 380-780 nm range to the absorbed power between 950 and 1000 nm, is calculated from these two steps.

### EXAMPLE 1

### Y₂BaZnO₅:Yb³⁺/Er³⁺ and Gd₂BaZnO₅:Yb³⁺/Er³⁺

Phosphors of formula Y₂BaZnO₅:Yb³⁺/Er³⁺ (formula A) and Gd₂BaZnO₅:Yb³⁺/Er³⁺ (formula B) were prepared by solid-phase reaction. Y₂O₃ or Gd₂O₃, Yb₂O₃, Er₂O₃ (Alfa Aesar; 99.99%), ZnO (Fisher Scientific; 99.5%) and BaCO₃ (Fisher Scientific; 99%+) powders were blended, milled together and then sintered at 1200° C. for three days, with intermediate milling steps.

The crystal structure was orthorhombic and belonged to the Pnma space group. For Yb³⁺ and Er³⁺ dopant contents of 7% and 3% respectively (corresponding to t1=0.07 and t2=0.03), the lattice parameters were the following: a=1.23354 nm; b=0.570897 nm; and c=0.706887 nm (formula A) and a=1.24861 nm; b=0.57713 nm; and c=0.71720 nm (formula B).

When exposed to excitation radiation of about 977 nm, the specimens exhibited luminescence ranging from green to orange, characterized by a strong emission in the red (at around 673 nm, due to a transition between the ⁴F_{9/2} and ⁴I_{15/2} levels of erbium) and in the green (at around 548 nm, due to a transition between the ⁴S_{3/2} and ⁴I_{15/2} levels of erbium). FIG. 1 shows the emission spectrum obtained.

It is possible to vary both the luminescence efficiency and the red/green intensity ratio by modifying the dopant contents.

Thus, for a 3% erbium ion content (t2=0.03), by varying the ytterbium ion content from 3% to 11% (t1 from 0.03 to 0.11) it is possible for the red/green intensity ratio (defined as the ratio of the intensity of the emission band centered around 673 nm to the intensity of the emission band centered around 550 nm) to vary from 4 to 8.

FIG. 2 shows that, for a constant (t1+t2) content (equal to 0.1), the increase in content t2 (erbium ion concentration) considerably reduces the emission in the red (the band at around 670 nm) in favor of emission in the green (the band at around 550 nm).

FIG. 3 indicates the luminescence efficiency as a function of the erbium ion (t2) and ytterbium ion (t1) concentration. It may be seen that when t1 (Yb³⁺ ion concentration) varies from 0.05 to 0.1 and t2 (Er³⁺ ion concentration) varies from 0.02 to 0.07, the luminescence efficiency is generally at least 3% and exceeds 4%, or even 5% when t1 varies from 0.07 to 0.09 and t2 varies from 0.03 to 0.04.

For Yb³⁺ and Er³⁺ dopant contents of 7% (t1=0.07) and 3% (t2=0.03) respectively, the luminescence efficiency at room temperature is 5.2%±0.2%, both for formula A and formula B. These particularly efficient phosphors have the following formulae: Y_{1.8}Yb_{0.14}Er_{0.06}BaZnO₅ and Gd_{1.8}Yb_{0.14}Er_{0.06}BaZnO₅.

For the same dopant content, the red/green intensity ratio may also be adjusted or modified by varying the duration of the laser pulses. The red/green intensity ratio increases continuously with the pulse duration (between 0.05 and 1 millisecond) and then stabilizes for longer pulses. For very short pulses (of less than 0.25 milliseconds), the red/green intensity ratio is less than 1 so that the light emitted is mainly green. For longer pulses, the light emitted becomes orange and then red. FIG. 4 illustrates this phenomenon, the variation in red/green intensity ratio being plotted as a function of the pulse duration.

### EXAMPLE 2

### Y₂BaZnO₅:Yb³⁺/Tm³⁺

Phosphors of formula Y₂BaZnO₅:Yb³⁺/Tm³⁺ were prepared by solid-phase reaction. Y₂O₃, Yb₂O₃ and Tm₂O₃ (Alfa Aesar, 99.99%), ZnO (Fisher Scientific 99.5%) and BaCO₃ (Fisher Scientific 99%+) powders were blended, milled together and then sintered at 1200° C. for three days, with intermediate milling steps.

FIG. 5 shows the typical emission spectrum obtained for these phosphors when they are exposed to radiation of about 975 nm wavelength. The main emission band is predominantly located in the infrared, at around 800 nm. Two less intense bands are located at around 480 nm (in the blue) and 650 nm (in the red). To the eye, the light emitted appears blue.

FIGS. 6a and 6b indicate the luminescence efficiency as a function of the Yb³⁺ (t1) and Tm³⁺ (t3) concentrations in the emission range from 420 to 870 nm (FIG. 6a) and from 420 to 530 nm (FIG. 6b). For a 10% Yb³⁺ content (t1=0.1) and a 1% Tm³⁺ content (t3=0.01), it is possible to obtain a luminescence efficiency of 1.33% at room temperature. The phosphor has the formula Y_{1.78}Yb_{0.2}Tm_{0.02}BaZnO₅.

For a 6% Yb³⁺ content (t1=0.06) and a 0.25% Tm³⁺ content (t3=0.0025), the luminescence efficiency obtained is 1.7% at room temperature. The phosphor has the formula Y_{1.83}Yb_{0.12}Tm_{0.05}BaZnO₅.

### EXAMPLE 3

### Y₂BaZnO₅:Yb³⁺/Ho³⁺

Phosphors of formula Y₂BaZnO₅:Yb³⁺/Ho³⁺ were prepared by solid-phase reaction, Y₂O₃, Yb₂O₃ and Ho₂O₃ (Alfa Aesar, 99.99%), ZnO (Fisher Scientific; 99.5%) and BaCO₃ (Fisher Scientific; 99%+) powders were blended, milled together and then sintered at 1200° C. for 3 days, with intermediate milling steps.

FIG. 7 shows the typical emission spectrum obtained for these phosphors when they are exposed to radiation of about 975 nm wavelength. The main emission bad is predominantly located in the green (at around 550 nm). Two markedly less intense bands are located at around 760 nm (in the red and near infrared) and at 660 nm (in the red). To the eye, and on account of the higher sensitivity of the human eye for green, the emitted light is a very bright green.

FIG. 8 is a map showing the variation of the luminescence efficiency at room temperature as a function of the Yb³⁺ (t1) and Ho³⁺ (t4) dopant contents. The highest efficiencies are obtained for Yb³⁺ contents ranging from 6% to 12% (t1 ranging from 0.06 to 0.12) and Ho³⁺ contents ranging from 0.25% to 2% (t4 ranging from 0.0025 to 0.02).

An efficiency of 2.6% at room temperature was obtained for phosphors of formulae Y_{1.85}Yb_{0.14}Ho_{0.01}BaZnO₅ and Y_{1.18}Yb_{0.18}Ho_{0.01}BaZnO₅.

The efficiency varies with the temperature of the laser diode, the optimum being at a temperature of about 75° C.

### EXAMPLE 4

### Ln₂BaZnO₅:Yb³⁺/Er³⁺/Tm³⁺

Phosphors of formula Y₂₍₁₋ₜ₁₋ₜ₂₋ₜ₃₎Yb₂ₜ₁Er₂ₜ₂Tm₂ₜ₃BaZnO₅ were prepared by solid-phase reaction. Y₂O₃, Yb₂O₃, Er₂O₃ and Tm₂O₃ (Alfa Aesar; 99.99%), ZnO (Fisher Scientific; 99.5%) and BaCO₃ (Fisher Scientific; 99%) powders were blended, milled together and then sintered at 1200° C. for 3 days, with intermediate milling steps.

Table 1 below indicates, for various values of t1, t2, t3 and the power of the laser diode, the colorimetric coordinates in the x,y colorimetric system of the radiation emitted in response to excitation at a wavelength of about 975 nm.

TABLE 1

| | % Yb³⁺ | % Er³⁺ | % Tm³⁺ | Power | | |
|---|---|---|---|---|---|---|
| No. | (t1) | (t2) | (t3) | (mW) | x | y |
| 1 | 0.1 | 0.005 | 0.01 | 45 | 0.3369 | 0.3646 |
| 2 | 0.1 | 0.005 | 0.01 | 29 | 0.3516 | 0.3689 |
| 3 | 0.1 | 0.005 | 0.01 | 13 | 0.3636 | 0.3650 |
| 4 | 0.1 | 0.004 | 0.01 | 45 | 0.3259 | 0.3448 |
| 5 | 0.1 | 0.004 | 0.01 | 29 | 0.3315 | 0.3412 |
| 6 | 0.1 | 0.004 | 0.01 | 13 | 0.3348 | 0.3222 |
| 7 | 0.1 | 0.004 | 0.01 | 2.7 | 0.3445 | 0.3167 |
| 8 | 0.1 | 0.002 | 0.01 | 45 | 0.2935 | 0.3031 |
| 9 | 0.1 | 0.002 | 0.01 | 29 | 0.3021 | 0.3097 |
| 10 | 0.1 | 0.002 | 0.01 | 13 | 0.3103 | 0.3049 |
| 11 | 0.1 | 0.002 | 0.01 | 2.7 | 0.3296 | 0.3071 |
| 12 | 0.1 | 0.001 | 0.01 | 12 | 0.2931 | 0.2644 |
| 13 | 0.1 | 0.001 | 0.01 | 2 | 0.2850 | 0.2669 |

White light is characterized by an x,y pair in which x and y are both equal to ⅓. It may be deduced from Table 1 that the progressive increase in erbium content enables the light to be shifted from blue to green, passing through white.

By modulating the power of the laser diode it is also possible to vary the color obtained, as is shown by comparing examples 1 to 3 or 4 to 7 or 8 to 11 or 12 and 13.

### EXAMPLE 5

### Phosphor Blends

A first phosphor A of formula Y_{1.8}Yb_{0.14}Er_{0.06}BaZnO₅ (t1=0.07 and t2=0.03) and a second phosphor B of formula Y_{1.78}Yb_{0.2}Tm_{0.02}BaZnO₅ (t1=0.1 and t3=0.01) were blended together. The ratio of the mass of phosphor B to the mass of phosphor A is denoted by R.

Table 2 below shows, for various values of R and the power of the laser diode, the colorimetric coordinates in the x,y colorimetric system of the radiation emitted in response to excitation at a wavelength of about 975 nm.

TABLE 2

| | | Diode | | |
|---|---|---|---|---|
| | | power | | |
| Test No. | R | (mW) | x | y |
| 14 | 0 | 45 | 0.4764 | 0.4966 |
| 15 | 0 | 13 | 0.4883 | 0.4843 |
| 16 | 5 | 45 | 0.4221 | 0.4506 |
| 17 | 5 | 13 | 0.4353 | 0.4388 |
| 18 | 10 | 45 | 0.3773 | 0.4019 |
| 19 | 10 | 13 | 0.3927 | 0.3949 |
| 20 | 20 | 45 | 0.3571 | 0.3662 |
| 21 | 20 | 13 | 0.3667 | 0.3582 |
| 22 | 25 | 45 | 0.3319 | 0.3398 |
| 23 | 25 | 13 | 0.3468 | 0.3387 |
| 24 | 30 | 45 | 0.3136 | 0.3260 |
| 25 | 30 | 29 | 0.3281 | 0.3476 |
| 26 | 30 | 13 | 0.3381 | 0.3440 |
| 27 | 30 | 2.7 | 0.3732 | 0.3641 |
| 28 | 35 | 45 | 0.2886 | 0.3031 |
| 29 | 35 | 13 | 0.3201 | 0.3250 |
| 30 | ∞ | 45 | 0.2053 | 0.1891 |
| 31 | ∞ | 13 | 0.2272 | 0.2084 |

By blending phosphors A and B it is possible to pass from emission in the orange to emission in the blue, passing through white light for a ratio R between 20 and 35, especially around 25 to 30.

Reducing the power of the laser diode generally results in an increase in the value of x.

### EXAMPLE 6

### Form Operation

Phosphor coatings 0.1 mm in thickness were obtained on sodar-lime-silica glass substrates in the following manner.

Phosphor particles according to the invention were blended with an organic medium (typically castor oil) and with a glass frit.

More precisely, the phosphors had the formula Y_{1.8}Yb_{0.14}Er_{0.06}BaZnO₅ or Y_{1.85}Yb_{0.14}Ho_{0.01}BaZnO₅. The glass frit consisted of SiO₂ (12 wt %), ZnO (40 wt %), Bi₂O₃ (29 wt %) and Na₂O (19 wt %).

After the resulting blend was deposited on the glass by means of a film coater, the specimens underwent a firing step at 600° C. for 6 minutes.

The emission spectrum after irradiation by laser radiation of about 980 nm wavelength is shown in FIG. 9. It comprises a main band at around 680 nm (in the red) and a secondary band at around 550 nm (in the green).

1. A crystalline phosphor of formula:
Ln_{x.(1-t1-t2-t3-t4)}Yb_{x.t1}Er_{x.t2}Tm_{x.t3}Ho_{x.t4}Ba_{y}Zn_{z}O_{1.5x+y+z}
in which:
Ln is Y or Gd;
t1+t2+t3+t4 varies from 0.001 to 0.3;
and such that, when x=2, y=1 and z=1:
t1+t3+t4 is nonzero;
if Ln is Gd and if t3+t4 is zero, then t1 varies from 0.05 to 0.1 and t2 varies from 0.02 to 0.07; and
if Ln is Gd, then t2+t4 is nonzero.

2. The phosphor as claimed in claim 1, wherein x=2, y=1 and z=1.

3. The phosphor as claimed in claim 1, wherein x=8, y=5 and z=4 or x=2, y=2 and z=8.

4. The phosphor as claimed in claim 1, wherein:
t3+t4 is zero;
t1 varies from 0.05 to 0.1; and
t2 varies from 0.02 to 0.07.

5. The phosphor as claimed in claim 1, wherein:
Ln is Y;
t2+t4 is zero; and
t1 and t3 are nonzero, t1 varying from 0.05 to 0.2 and t3 varying from 0.001 to 0.05.

6. The phosphor as claimed in claim 1, wherein:
t2+t3 is zero; and
t1 and t4 are nonzero, t1 varying from 0.06 to 0.12 and t4 varying from 0.001 to 0.02.

7. The phosphor as claimed in claim 1, wherein t1, t2 and t3 are nonzero.

8. A blend of at least two different phosphors as claimed in claim 1.

9. The blend as claimed in claim 8, comprising a first phosphor such that t3+t4=0 and t1 and t2 are nonzero and a second phosphor such that t2+t4=0 and t1 and t3 are nonzero.

10. A process for obtaining the phosphor as claimed in claim 1, comprising blending powders, milling the blend and heating the blend so as to make the powders react chemically with one another.

11. A process for obtaining the phosphor as claimed in claim 1, comprising dissolving precursors in water or in a predominantly aqueous solvent, adding a complexing agent and optionally a crosslinking agent so as to obtain a gel, and heating the resulting gel at a temperature of at least 1000° C.

12. A substrate coated over at least part of a face thereof with a coating incorporating a phosphor as claimed in claim 1.

13. A display device or a photovoltaic energy production device comprising a substrate as claimed in claim 12.

14. A method comprising converting infrared radiation into visible radiation with a phosphor as claimed in claim 1.

15. The phosphor as claimed in claim 1, wherein t1+t2+t3+t4 varies from 0.01 to 0.2.

16. The phosphor as claimed in claim 4, wherein t1 varies from 0.07 to 0.09, and t2 varies from 0.03 to 0.04.

17. The process as claimed in claim 11, wherein the precursors include nitrates, acetates or carbonates, and wherein the complexing agent includes an α-hydroxycarboxylic acid and the optional crosslinking agent includes a polyhydroxyalcohol.

18. The process as claimed in claim 17, wherein the α-hydroxycarboxylic acid is citric acid.

19. The process as claimed in claim 17, wherein the polyhydroxyalcohol is ethylene glycol.

20. The method as claimed in claim 14, wherein the infrared radiation having a wavelength in a range from 890 to 1100 nm is converted into radiation having a wavelength of about 550 nm and/or 660 nm and/or 480 nm and/or 800 nm.

21. The method as claimed in claim 20, wherein the infrared radiation has a wavelength of about 975 nm.
